(19) United States
(12) Patent Application Publication
(10) Pub. No.: US 2020/0294114 A1
(43) Pub. Date: Sep. 17, 2020

(54) SYSTEM AND METHOD FOR GENERATING A PLURALITY OF PRODUCT LISTING PAGES IN AN E-COMMERCE PLATFORM

(71) Applicant: TAGALYS, LLC, Newark, DE (US)

(72) Inventors: Antony Kattukaran, Chennai (IN); Palaniappan Chellappan, Chennai (IN)

(21) Appl. No.: 16/593,945

(22) Filed: Oct. 4, 2019

Related U.S. Application Data
(60) Provisional application No. 62/818,888, filed on Mar. 15, 2019.

(51) Int. Cl. G06Q 30/06

(52) U.S. Cl. CPC G06Q 30/0633; G06Q 30/0603

(57) ABSTRACT

A system for generating a plurality of product listing pages is disclosed. The system includes a retailer registration subsystem to register a plurality of retailer details obtained from corresponding one or more retailers. The system includes an attributes collection subsystem to collect one or more attributes of a product corresponding to one or more registered retailers from a retailer e-commerce platform. The system includes a page generation subsystem to generate the plurality of product listing pages dynamically based on a combination of one or more collected attributes and one or more product tags. Each of the plurality of product listing page is dynamically generated based on a combination of each of the corresponding one or more attributes and each of the corresponding one or more product tags. The page generation subsystem is to update and manage a plurality of generated product listing pages.

This application claims priority from a provisional patent application filed in the US having Patent Application No. 62/818,888, filed on Mar. 15, 2019 and titled “SYSTEM AND METHOD FOR GENERATING A PLURALITY OF PRODUCT LISTING PAGES IN AN E-COMMERCE PLATFORM”.

### BACKGROUND

Embodiments of a present disclosure relate to a page creation system, and more particularly to a system and a method for generating a plurality of product listing pages in an e-commerce platform.

Electronic systems which support Merchant to Visitor sales of products have become popular. Such Merchant to Visitor sales systems typically include an electronic server system, such as a web site or an online services network, that provides services for users to list products for sale to, and purchase products from, other users. Existing Merchant to Visitor sales systems typically support fixed-price sales, auctions, or both.

Product listing pages are created by merchants to allow their visitors (users) to discover products on their store front. Product listings can typically be located using a web search engine. In some cases, the Merchant to Visitor sales system is operated in association with an online retail store such that a visitor can search a retail catalogue, as well as a database of product listings from merchants, via a single site search query within the e-commerce platform. Various approaches have been adopted by the merchant to visitor sales systems to list the products on the storefront.

The retailers have to create category or product listing pages manually on e-commerce platform or by applying filters in the front end. Once the page is created, the content on the page was delivered to online visitors from the merchant's server with limited or no curation capabilities.

Merchant to Visitor sales systems have the need to attract large numbers of online visitors via web search engines to increase online traffic. This need can be potentially satisfied by potentially generating large number of unique listing pages of products. However, such systems commonly suffer from a number of deficiencies. For example, existing systems rely on merchants to supply meta descriptions of all the pages to make them discoverable by search engines. The task of adding content to the pages is manual, cumbersome & prone to human error. For example, to create an effective listing page to attract organic traffic, the retailer must provide unique content about the listing page which is various meta fields like page title, description, meta keywords, or meta description.

Hence, there is a need for an improved system and method for generating a product listing page to address the aforementioned issues.

### BRIEF DESCRIPTION

In accordance with an embodiment of the present disclosure, a system for generating a plurality of product listing page on an e-commerce platform is provided. The system includes a retailer registration subsystem configured to register a plurality of retailer details obtained from a retailer. The system also includes an attributes collection subsystem operatively coupled to a retailer ecommerce platform and the retailer registration subsystem. The attributes collection subsystem is configured to collect one or more attributes of a product corresponding to a registered retailer from a retailer e-commerce platform. The system further includes a page generation subsystem operatively coupled to the attributes collection subsystem. The page generation subsystem is configured to generate the plurality of product listing pages dynamically based on a combination of one or more collected attributes and one or more product tags of the one or more collected attributes. Each of the plurality of product listing page is dynamically generated based on a combination of each of the corresponding one or more attributes and each of the corresponding one or more product tags. The page generation subsystem is also configured to update and manage a plurality of generated product listing pages based on a requirement of the registered retailer.

In accordance with another embodiment of the present disclosure, a method for generating a plurality of product listing pages on an e-commerce platform is provided. The method includes registering, by a retailer registration subsystem, a plurality of retailer details obtained from a retailer. The method also includes collecting, by an attributes collection subsystem, one or more attributes of a product corresponding to a registered retailer from a retailer e-commerce platform. The method further includes generating, by a page generation subsystem, a plurality of product listing pages dynamically based on a combination of one or more collected attributes and one or more product tags of the one or more collected attributes, wherein each of the plurality of product listing page is dynamically generated based on a combination of each of the corresponding one or more attributes and each of the corresponding one or more product tags. The method further includes updating and managing, by the page generation subsystem, a plurality of generated product listing pages based on a requirement of the registered retailers.

To further clarify the advantages and features of the present disclosure, a more particular description of the disclosure will follow by reference to specific embodiments thereof, which are illustrated in the appended figures. It is to be appreciated that these figures depict only typical embodiments of the disclosure and are therefore not to be considered limiting in scope. The disclosure will be described and explained with additional specificity and detail with the appended figures.

### BRIEF DESCRIPTION OF THE DRAWINGS

The disclosure will be described and explained with additional specificity and detail with the accompanying figures in which:

FIG. 1 is a block diagram representation of a system for generating a plurality of product listing pages on an e-commerce platform in accordance with an embodiment of the present disclosure;

FIG. 2 is a block diagram of one embodiment of the system for generating a plurality of product listing pages on an e-commerce platform of FIG. 1 in accordance in an embodiment of the present disclosure;

FIG. 3 is a block diagram representation of an exemplary embodiment of the system for generating the plurality of product listing pages on the e-commerce platform of FIG. 1 in accordance with an embodiment of the present disclosure;

FIG. 4 is a pictorial representation of one embodiment of the exemplary system for generating a plurality of product listing pages of FIG. 3 in accordance with an embodiment of the present disclosure;

FIG. 5 is a pictorial representation of another embodiment of the exemplary system for generating a plurality of product listing pages of FIG. 3 in accordance with an embodiment of the present disclosure:

FIG. 6 is a block diagram of a computer or a server in accordance with an embodiment of the present disclosure; and

FIG. 7 is a flow chart representing the steps involved in a method for generating a plurality of product listing pages on an e-commerce platform in accordance with the embodiment of the present disclosure.

Further, those skilled in the art will appreciate that elements in the figures are illustrated for simplicity and may not have necessarily been drawn to scale. Furthermore, in terms of the construction of the device, one or more components of the device may have been represented in the figures by conventional symbols, and the figures may show only those specific details that are pertinent to understanding the embodiments of the present disclosure so as not to obscure the figures with details that will be readily apparent to those skilled in the art having the benefit of the description herein.

### DETAILED DESCRIPTION

For the purpose of promoting an understanding of the principles of the disclosure, reference will now be made to the embodiment illustrated in the figures and specific language will be used to describe them. It will nevertheless be understood that no limitation of the scope of the disclosure is thereby intended. Such alterations and further modifications in the illustrated system, and such further applications of the principles of the disclosure as would normally occur to those skilled in the art are to be construed as being within the scope of the present disclosure.

The terms “comprises”, “comprising”, or any other variations thereof, are intended to cover a non-exclusive inclusion, such that a process or method that comprises a list of steps does not include only those steps but may include other steps not expressly listed or inherent to such a process or method. Similarly, one or more devices or sub-systems or elements or structures or components preceded by “comprises . . . a” does not, without more constraints, preclude the existence of other devices, sub-systems, elements, structures, components, additional devices, additional sub-systems, additional elements, additional structures or additional components. Appearances of the phrase “in an embodiment”, “in another embodiment” and similar language throughout this specification may, but not necessarily do, all refer to the same embodiment.

Unless otherwise defined, all technical and scientific terms used herein have the same meaning as commonly understood by those skilled in the art to which this disclosure belongs. The system, methods, and examples provided herein are only illustrative and not intended to be limiting.

In the following specification and the claims, reference will be made to a number of terms, which shall be defined to have the following meanings. The singular forms “a”, “an”, and “the” include plural references unless the context clearly dictates otherwise.

Embodiments of the present disclosure relate to a system and method for generating a plurality of product listing pages on an e-commerce platform. The system includes a retailer registration subsystem configured to register a plurality of retailer details obtained from corresponding one or more retailers. The system also includes an attributes collection subsystem operatively coupled to a retailer ecommerce platform and the retailer registration subsystem. The attributes collection subsystem is configured to collect one or more attributes of a product corresponding to one or more registered retailers from a retailer e-commerce platform. The system further includes a page generation subsystem operatively coupled to the attributes collection subsystem. The page generation subsystem is configured to generate the plurality of product listing pages dynamically based on a combination of one or more collected attributes and one or more product tags of the one or more collected attributes. Each of the plurality of product listing page is dynamically generated based on a combination of each of the corresponding one or more attributes and each of the corresponding one or more product tags. The page generation subsystem is also configured to update and manage a plurality of generated product listing pages based on a requirement of the one or more registered retailers.

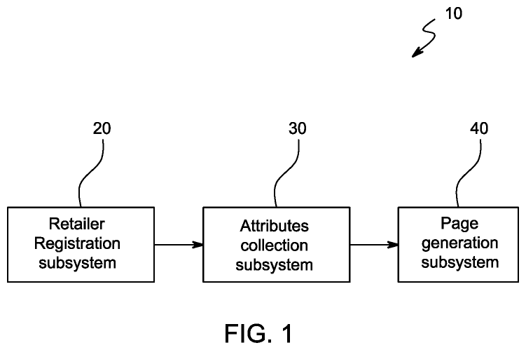

FIG. 1 is a block diagram of a system 10 for generating a plurality of product listing pages on an e-commerce platform in accordance with an embodiment of the present disclosure. The system 10 includes a retailer registration subsystem 20 configured to register a plurality of retailer details obtained from a retailer. As used herein, the term “retailer” is defined as a person or business that sells goods to the public or consumption rather than for resale. In one embodiment, the plurality of retailer details may include a plurality of product catalogue details. In such embodiment, the plurality of product catalogue details may include, but not limited to, at least one of a product name, a product description, a product price, a product link, a product image and the like. In another embodiment, the retailer registration subsystem 20 may enable the one or more retailers to create a login account with a user id and password.

Furthermore, the system 10 includes an attributes collection subsvystem 30 which is operatively coupled with the retailer registration subsystem 20. The attributes collection subsystem 30 is configured to collect one or more attributes of a product corresponding to a registered retailer from a retailer e-commerce platform. As used herein, the term “attributes” may be defined as a categories which is a characteristic that defines a particular product and affect a consumer's purchase decision. In one embodiment, the one or more attributes may be tangible attributes such as but not limited to size, colour, weight, volume, smell, taste, touch, quantity, material composition and the like. In another embodiment, the one or more attributes may be intangible attributes such as but not limited to price, quality, reliability, beauty aesthetics and the like.

Moreover, the system 10 further includes a page generation subsystem 40 operatively coupled to the attributes collection subsystem 30. The page generation subsystem 40 is configured to generate the plurality of product listing pages dynamically based on a combination of one or more collected attributes and one or more product tags of the one or more collected attributes. As used herein the term “page” is defined as a webpage which is a hypertext document connected to the World Wide Web. Each of the plurality of product listing page is dynamically generated based on a combination of each of the corresponding one or more attributes and each of the corresponding one or more product tags. In one embodiment, the one or more attributes may include one or more corresponding tags. As used herein the term “product tag” is defined as descriptors assigned to specific products and contains keywords or key phrases for each respective product. For example, if the attribute is shape then the tags may include round, rectangular, square and the like.

The page generation subsystem 40 is also configured to update and manage a plurality of generated product listing pages based on a requirement of the one or more registered retailers. In one embodiment, the plurality of product listing pages may be a plurality of search engine optimized pages based on a requirement of the one or more retailers. As used herein, “the search engine optimization (SEO)” is a process of increasing the quality and quantity of website traffic by increasing visibility of a website or a web page to users of a web search engine. In one embodiment, the page generation subsystem 40 may be search engine optimized to increase the visibility of the website of the one or more retailers. In a specific embodiment, the page generation subsystem 40 may be configured to extract one or more selections performed among the one or more generated product listing pages from the corresponding one or more registered retailers. In a preferred embodiment, the page generation subsystem 40 may also be configured to generate one or more new pages when new data provided by the registered retailer matches with existing conditions.

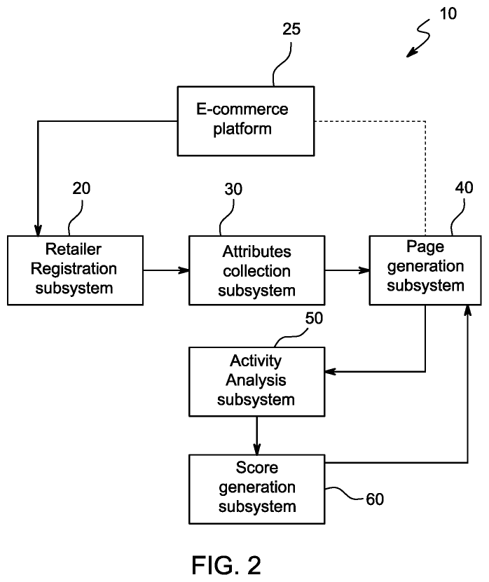

FIG. 2 is a block diagram representation of one embodiment of the system 10 for generating the plurality of product listing pages on an e-commerce platform of FIG. 1 in accordance with an embodiment of the present disclosure. The system 10 includes the retailer registration subsystem 20 configured to register a plurality of retailer details obtained from a retailer. The system 10 also includes the attributes collection subsystem 30 operatively coupled to a retailer ecommerce platform and the retailer registration subsystem 20. The attributes collection subsystem 30 is configured to collect one or more attributes of a product corresponding to a registered retailer from a retailer e-commerce platform 25.

The system 10 further includes the page generation subsystem 40 operatively coupled to the attributes collection subsystem 30. The page generation subsystem 40 is configured to generate the plurality of product listing pages dynamically based on a combination of one or more collected attributes and one or more product tags of the one or more collected attributes. Each of the plurality of product listing page is dynamically generated based on a combination of each of the corresponding one or more attributes and each of the corresponding one or more product tags. The page generation subsystem 40 is also configured to update and manage a plurality of generated product listing pages based on a requirement of the registered retailer.

In one embodiment, the system 10 may include an activity analysis subsystem 50 which is operatively coupled to the page generation subsystem 40. The activity analysis subsystem 50 is configured to analyse a plurality of activities of one or more visitors on the plurality of generated product listing pages and the associated the retailer e-commerce platform 25. In such embodiment, the plurality of activities may include a number of visits of a customer on each of the plurality of product listing page and associated the retailer e-commerce platform 25, purchasing behaviour, Wishlist behaviour, products added to cart and number of products viewed. For example, the activity analysis subsystem 50 tracks information about the one or more visitors and the plurality of activities performed by the corresponding one or more visitors on the website such as what they view, what they add to cart and what they buy. In some embodiments, the activity analysis subsystem 50 may be configured to generate a performance report on a predefined time interval based on a plurality of analysed activities. In such embodiment, the performance report may include performance data, conversion rate and sales data of each of the plurality of product listing pages.

In some embodiments, the system 10 may include a score generation subsystem 60 which is operatively coupled to the activity analysis subsystem 50. The score generation subsystem 60 is configured to generate a score for one or more products, listed on the plurality of generated product listing pages, based on a plurality of analysed activities. In such embodiment, the score generation subsystem 60 may be configured to rearrange the one or more products on the plurality of generated product listing pages based on a generated score. Each of the plurality of generated product listing pages are sorted by descending order of the generated score of the products on the each of the plurality of generate product listing pages. The sort order may be a trending sort order. The plurality of activities of the one or more visitors on the each of the plurality of generated product listing pages may change the order of the product.

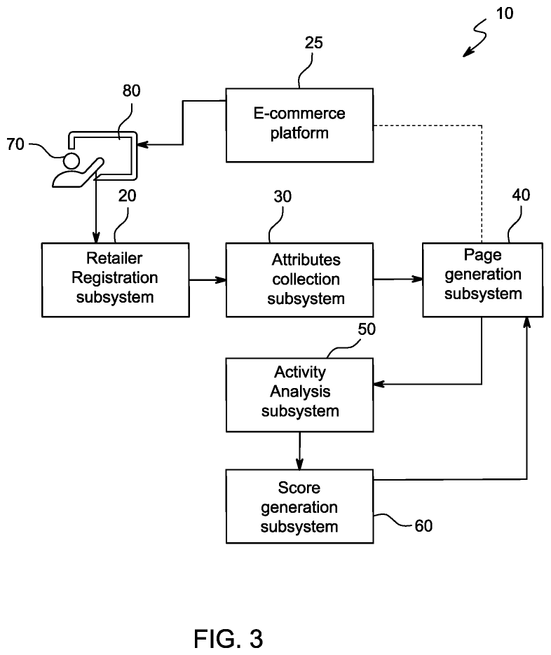

FIG. 3 is a block diagram representation of an exemplary embodiment of the system 10 for generating a plurality of product listing pages on an e-commerce platform of FIG. 1 in accordance with an embodiment of the present disclosure. Considering an example, where a retailer ‘A’ 70 has an e-commerce platform 80 to sell jewelleries. In view of this, he is interested in generating a plurality of product listing pages. The retailer ‘A’ 70 installs a programmed application programming interface in an electronic device. Further, the retailer ‘A’ 70 provides a plurality of catalogue details present on the retailer e-commerce platform 80 such as product list, product name, product image, product link, product price and the like to a retailer registration subsystem 20 of the system 10 associated with the application programming interface to get registered on the system 10. Also, the retailer ‘A’ 70 creates an account on the system 10 with a user id and password to complete the registration process. After registration, the retailer ‘A’ 70 login the account using the registered user id and the password. After login, an attributes collection subsystem 30 of the system 10 collects the one or more attributes of the products from the retailer e-commerce platform 80. The one or more attributes may include the one or more tags, wherein the one or more attributes may include size, colour, weight, volume, smell, taste, touch, quantity, material composition, price, quality, reliability, beauty aesthetics and the like as per the requirement of the retailer ‘A’ 70.

For example, retailer ‘A’ 70 has listed all types of jewelleries such as pendants, bangles, necklaces, earrings, chain, bracelets, nose pins and the like. The pricing details and the availability details of the corresponding listed products are also collected by the attributes collection subsystem 30. The attributes collection subsystem 30 collects the one or more attributes of the jewelleries such as types of jewellery, gender, weight of the jewellery, style of the jewellery, shape and size of the jewellery, category for product URL, region of sell, karat filter details, colour of the jewellery, design of the jewellery and occasion based filter details present on the retailer e-commerce platform 80. After collecting the one or more attributes of the jewelleries present of the retailer e-commerce platform 80 as per the interest of the retailer ‘A’ 70, the page generation subsystem 40 of the system 10 generates a plurality of product listing pages based on a combination of one or more collected attributes and one or more product tags of the one or more collected attributes. Each of the plurality of product listing page is generated based on the combination of each of the corresponding one or more attributes and each of the corresponding one or more product tags.

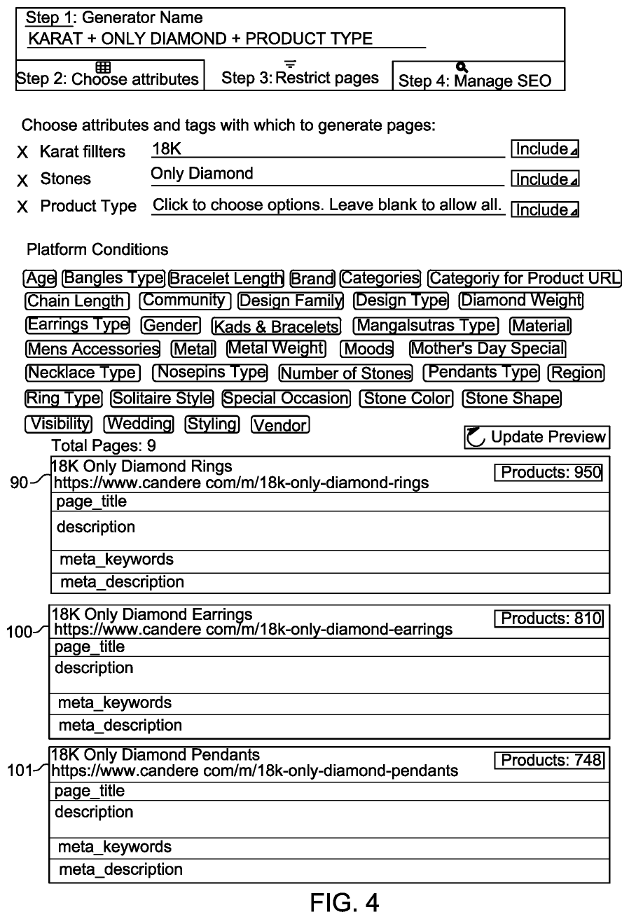

For example, retailer ‘A’ 70 wants to create a plurality of pages of “only diamond jewellery with karat information”, then the page generation subsystem 40 enables the retailer ‘A’ 70 to select the product tag such as “18K” as karat information and “only diamond” as stone type of the jewellery for the one or more collected attributes of the products present on the retailer e-commerce platform 80. Based on the combination of selected karat information and the one or more attributes such as types of jewellery the page generation subsystem 40 generates a plurality of product listing pages such as “18K only diamond Rings” 90, “18K only diamond earrings” 100, “18K only diamond pendants” 101 and the like shown in FIG. 4.

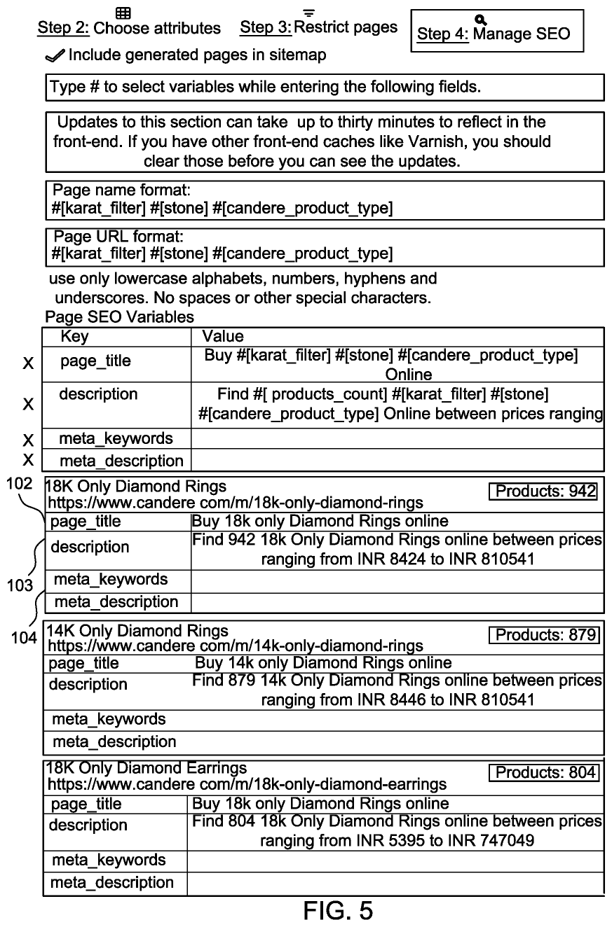

Based on the plurality of generated product listing pages, the page generation subsystem 40 enables the retailer ‘A’ 70 to update and manage the plurality generated product listing pages at predefined time intervals. The page generation subsystem 40 enables the retailer to manage the plurality of generated product listing pages for updating “page title” 102, “description” 103, meta keywords” 104 and the like as shown in FIG. 5. In some cases, after the page generation when the plurality of visitors visits the plurality of generated product listing pages on the retailer e-commerce platform 80, an activity analysis subsystem 50 of the system 10 may analyse the plurality of activities of the visitors (such as number of visits, number of products viewed (for example, 18K only diamond rings) by the visitors) to evaluate the popularity of the “18K only diamond rings” listed on the page. Based on the popularity of 18K only diamond rings, a score generation subsystem 60 may generate a score for that product. Further, the score generation subsystem 60 may rearrange the one or more products based on the generated score (for example, most popular product is positioned on the top of the list).

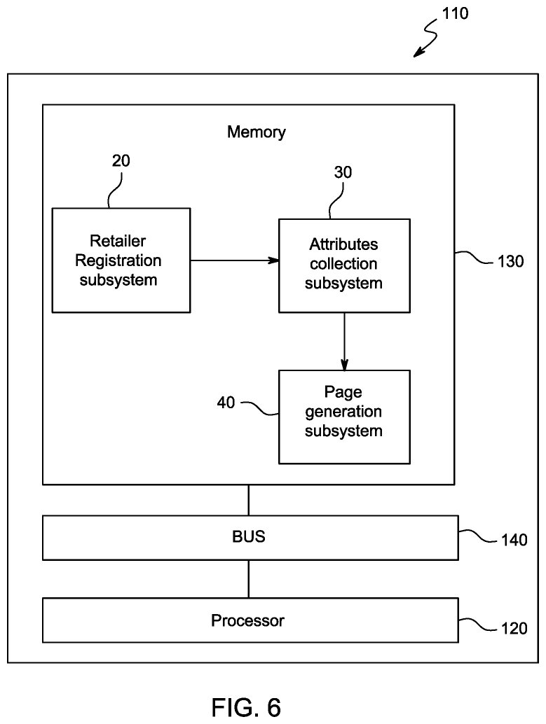

FIG. 6 is a block diagram of a computer or a server 110 in accordance with an embodiment of the present disclosure. The server 110 includes processor(s) 120, and memory 130 operatively coupled to the bus 140. The processor 120 and memory 130 are substantially to similar to the system for generating a plurality of product listing pages of FIG. 1.

The processor(s) 120, as used herein, means any type of computational circuit, such as, but not limited to, a microprocessor, a microcontroller, a complex instruction set computing microprocessor, a reduced instruction set computing microprocessor, a very long instruction word microprocessor, an explicitly parallel instruction computing microprocessor, a digital signal processor, or any other type of processing circuit, or a combination thereof.

The memory 130 includes a plurality of subsystems stored in the form of executable program which instructs the processor 120 to perform the method steps illustrated in FIG. 1. The memory 130 is substantially similar to the system 10 of FIG. 1. The memory 130 has following subsystems: a retailer registration subsystem 20, an attributes collection subsystem 30, and a page generation subsystem 40.

The retailer registration subsystem 20 configured to register a plurality of retailer details obtained from a retailer. The memory 130 also includes an attributes collection subsystem 30 operatively coupled to a retailer ecommerce platform and the retailer registration subsystem 20. The attributes collection subsystem 30 is configured to collect one or more attributes of a product corresponding to a registered retailers from a retailer e-commerce platform. The memory 130 further includes a page generation subsystem 40 operatively coupled to the attributes collection subsystem 30. The page generation subsystem 40 is configured to generate the plurality of product listing pages dynamically based on a combination of one or more collected attributes and one or more product tags of the one or more collected attributes. Each of the plurality of product listing page is dynamically generated based on a combination of each of the corresponding one or more attributes and each of the corresponding one or more product tags. The page generation subsystem 40 is also configured to update and manage a plurality of generated product listing pages based on a requirement of the registered retailers.

Computer memory elements may include any suitable memory device(s) for storing data and executable program, such as read only memory, random access memory, erasable programmable read only memory, electrically erasable programmable read only memory, hard drive, removable media drive for handling memory cards and the like. Embodiments of the present subject matter may be implemented in conjunction with program modules, including functions, procedures, data structures, and application programs, for performing tasks, or defining abstract data types or low-level hardware contexts. Executable program stored on any of the above-mentioned storage media may be executable by the processor(s) 120.

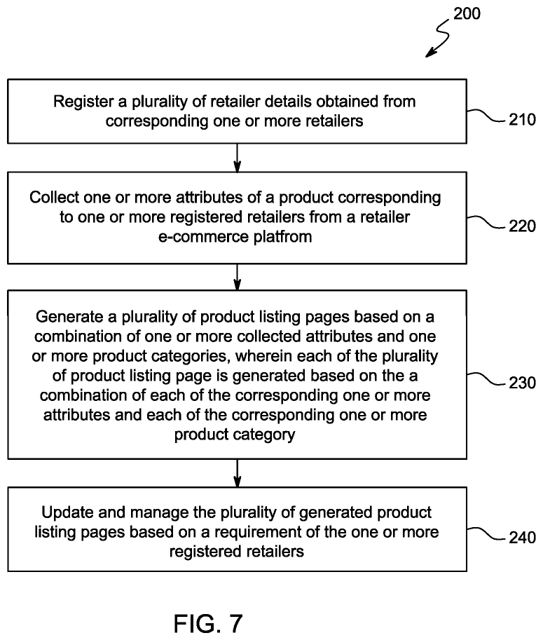

FIG. 7 is a flow chart representing the steps involved in a method 200 for generating a plurality of product listing pages in an e-commerce platform in accordance with an embodiment of the present disclosure. The method 200 includes registering, by a retailer registration subsystem, a plurality of retailer details obtained from a retailer in step 210. In one embodiment, registering the plurality of retailer details obtained from the retailer may include registering a plurality of product catalogue details obtained from the retailer. In such embodiment, registering the plurality of product catalogue details obtained from corresponding one or more retailers may include receiving at least one of a product name, a product description, a product price, a product link, a product image and the like from the registered retailer.

Furthermore, the method 200 includes collecting, by an attributes collection subsystem, one or more attributes of a product corresponding to the registered retailer from the retailer e-commerce platform in step 220. In one embodiment, collecting the one or more attributes of the product corresponding to the registered retailer from the retailer e-commerce platform may include collecting at least one of size, colour, weight, volume, smell, taste, touch, quantity, material composition, price, quality, reliability, beauty, aesthetics of the product and the like.

Moreover, the method 200 includes generating, by a page generation module, plurality of product listing pages based on a combination of one or more collected attributes and one or more product categories, wherein each of the plurality of product listing page is generated based on the a combination of each of the corresponding one or more attributes and each of the corresponding one or more product category in step 230. In one embodiment, the method may include extracting, by the page generation module, one or more selection among the plurality of generated product listing pages from the corresponding one or more registered retailers.

In addition, the method 200 also includes updating and managing, by the page generation module, the plurality of generated product listing pages based on a requirement of the registered retailer in step 240. In some embodiment, the method may include generating, by the page generation module, one or more new pages when new data provided by the corresponding retailer matches with existing conditions. In a specific embodiment, updating and managing the plurality of generated product listing pages based on the requirement of the registered retailers may include updating and managing a plurality of search engine optimized pages based on the requirement of the registered retailers.

In one embodiment, the method 200 may include analysing, by an activity analysis module, a plurality of activities of one or more visitors on the plurality of generated product listing pages and the associated retailer e-commerce platform. In such embodiment, analysing the plurality of activities of the one or more visitors on the plurality of generated product listing pages and the associated retailer e-commerce platform may include analysing at least one of a number of visits of a customer on each of the plurality of product listing page, a purchasing behaviour, a wishlist behaviour, number of products viewed and the like.

In some embodiments, the method 200 may include generating, by the activity analysis module, a performance report on a predefined time interval based on a plurality of analysed activities. In such embodiment, generating the performance report on the predefined time interval based on the plurality of analysed activities may include generating the performance report with performance data, conversion data, sales data and the like. In a specific embodiment, generating the performance report may include generating the performance report in the form of at least one of a text, a graph or a chart. In some embodiments, the method 200 may include, evaluating popularity of the one or more products listed on the plurality of generated product listing pages based on the plurality of activities.

Subsequently, the method 200 may include generating, by a score generation module, a score for one or more products, listed on the plurality of generated product listing pages, based on a plurality of analysed activities such as popularity of the one or more products. In such embodiment, the method 200 may include rearranging the one or more products on the plurality of generated product listing pages based on a generated score.

Various embodiments of a system for generating the product listing page in the e-commerce platform describe above enables a fast and efficient way to create, update and manage category pages or product listing pages at scale with complete curation capabilities.

Furthermore, by using the template information, the one or more retailers who wish to control operation of the web page, without the stress, it is possible to update or produce the plurality of product listing pages.

While specific language has been used to describe the invention, any limitations arising on account of the same are not intended. As would be apparent to a person skilled in the art, various working modifications may be made to the method in order to implement the inventive concept as taught herein.

The figures and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, order of processes described herein may be changed and are not limited to the manner described herein. Moreover, the actions of any flow diagram need not be implemented in the order shown; nor do all of the acts need to be necessarily performed. Also, those acts that are not dependent on other acts may be performed in parallel with the other acts. The scope of embodiments is by no means limited by these specific examples.

We claim:

1. A system for generating a plurality of product listing pages in an e-commerce platform comprising:
a retailer registration subsystem configured to register a plurality of retailer details obtained from a retailer;
an attributes collection subsystem operatively coupled to a retailer ecommerce platform and the retailer registration subsystem, wherein the attributes collection subsystem is configured to collect one or more attributes of a product corresponding to a registered retailer from a retailer e-commerce platform;
a page generation subsystem operatively coupled to the attributes collection subsystem, wherein the page generation subsystem is configured to:
generate the plurality of product listing pages dynamically based on a combination of one or more collected attributes and one or more product tags of the one or more collected attributes,
wherein each of the plurality of product listing page is dynamically generated based on a combination of each of the corresponding one or more attributes and each of the corresponding one or more product tags; and
update and manage a plurality of generated product listing pages based on a requirement of the registered retailer.

2. The system of claim 1, wherein the plurality of retailer details comprises a plurality of product catalogue details.

3. The system of claim 1, wherein the plurality of product listing pages comprises a plurality of search engine optimized pages based on a requirement of the registered retailer.

4. The system of claim 1, further comprising an activity analysis subsystem operatively coupled to the page generation subsystem, wherein the activity analysis subsystem is configured to analyse a plurality of activities of one or more visitors on the plurality of generated product listing pages and associated retailer e-commerce platform.

5. The system of claim 4, wherein the plurality of activities comprises a number of visits of a customer on each of the plurality of product listing page, one or more products added to a cart, purchasing behaviour, Wishlist behaviour and number of products viewed.

6. The system of claim 4, wherein the activity analysis subsystem is configured to generate a performance report on a predefined time interval based on a plurality of analysed activities.

7. The system of claim 1, further comprising a score generation subsystem operatively coupled to the activity analysis subsystem, wherein the score generation subsystem is configured to generate a score for one or more products, listed on the plurality of generated product listing pages, based on a plurality of analysed activities.

8. The system of claim 7, wherein the score generation subsystem is configured to rearrange the one or more products on the plurality of generated product listing pages based on a generated score.

9. A method comprising:
registering, by a retailer registration subsystem, a plurality of retailer details obtained from a retailer;
collecting, by an attributes collection subsystem, one or more attributes of a product corresponding to a registered retailer from a retailer e-commerce platform, generating, by a page generation subsystem, a plurality of product listing pages dynamically based on a combination of one or more collected attributes and one or more product tags of the one or more collected attributes, wherein each of the plurality of product listing page is dynamically generated based on a combination of each of the corresponding one or more attributes and each of the corresponding one or more product tags; and
updating and managing, by the page generation subsystem, a plurality of generated product listing pages based on based on a requirement of the registered retailer.

10. The method of claim 9, further comprising analysing, by an activity analysis subsystem, a plurality of activities of one or more visitors on the plurality of generated product listing pages.

11. The method of claim 10, further comprising generating, by the activity analysis subsystem, a performance report on a predefined time interval based on a plurality of analysed activities.

12. The method of claim 10, further comprising generating, by a score generation subsystem, a score for one or more products, listed on the plurality of generated product listing pages, based on a plurality of analysed activities.
